(19) United States
(12) Patent Application Publication
(10) Pub. No.: US 2024/0327600 A1
(43) Pub. Date: Oct. 3, 2024

(54) DEPOLYMERIZATION LIQUID GENERATION SYSTEM

(71) Applicant: Honda Motor Co., Ltd., Tokyo (JP)

(72) Inventors: Tsuyoshi Baba, Wako-shi (JP); Shuta Suzuki, Wako-shi (JP)

(21) Appl. No.: 18/587,569

(22) Filed: Feb. 26, 2024

(30) Foreign Application Priority Data
Mar. 28, 2023 (JP) 2023-051931

(51) Int. Cl. C08J 11/12; C08J 11/14

(52) U.S. Cl. CPC C08J 11/12; C08J 11/14; C08J 2300/30

(57) ABSTRACT

A depolymerization liquid generation system includes: a depolymerization liquid generation device configured to knead waste plastics and predetermined liquid to generate depolymerization liquid; a depolymerization liquid concentration device configured to heat the depolymerization liquid generated by the depolymerization liquid generation device to separate the depolymerization liquid into concentrated depolymerization liquid and gas; and a condensing device configured to condense the gas separated by the depolymerization liquid concentration device to generate condensed liquid. The depolymerization liquid generation device includes a kneader configured to knead the waste plastics and the predetermined liquid. The condensed liquid generated by the condensing device is mixed into the kneader.

### CROSS-REFERENCE TO RELATED APPLICATION

This application is based upon and claims the benefit of priority from Japanese Patent Application No. 2023-051931 filed on Mar. 28, 2023, the content of which is incorporated herein by reference.

### BACKGROUND OF THE INVENTION

### Field of the Invention

The present invention relates to a depolymerization liquid generation system for depolymerizing waste plastics to generate a depolymerization liquid.

### Description of the Related Art

As this type of device, there has been conventionally known a device for chemically recycling waste plastics into a raw material is known (see, for example, JP 2020-169328 A). In the device described in JP 2020-169328 A, a fuel to be used in a furnace is generated using a depolymerization reaction of waste plastics using high-temperature and high-pressure water as a medium.

Incidentally, in the depolymerization reaction of waste plastics using the high-temperature and high-pressure water as the medium, because it is necessary to add approximately three times as much water to the waste plastics, an amount of water with respect to a decomposition product in the generated depolymerization liquid increases. When the amount of water in the depolymerization liquid increases, the cost for transporting the depolymerization liquid to a polymerization plant for repolymerizing the depolymerization liquid increases, and the depolymerization liquid may be frozen in winter.

### SUMMARY OF THE INVENTION

An aspect of the present invention is a depolymerization liquid generation system, including: a depolymerization liquid generation device configured to knead waste plastics and predetermined liquid to generate depolymerization liquid; a depolymerization liquid concentration device configured to heat the depolymerization liquid generated by the depolymerization liquid generation device to separate the depolymerization liquid into concentrated depolymerization liquid and gas; and a condensing device configured to condense the gas separated by the depolymerization liquid concentration device to generate condensed liquid. The depolymerization liquid generation device includes a kneader configured to knead the waste plastics and the predetermined liquid. The condensed liquid generated by the condensing device is mixed into the kneader.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of a configuration of a depolymerization liquid generation system according to an embodiment of the present invention; and

FIG. 2 is a diagram schematically illustrating an example of a configuration of a depolymerization liquid generation device.

### DETAILED DESCRIPTION OF THE INVENTION

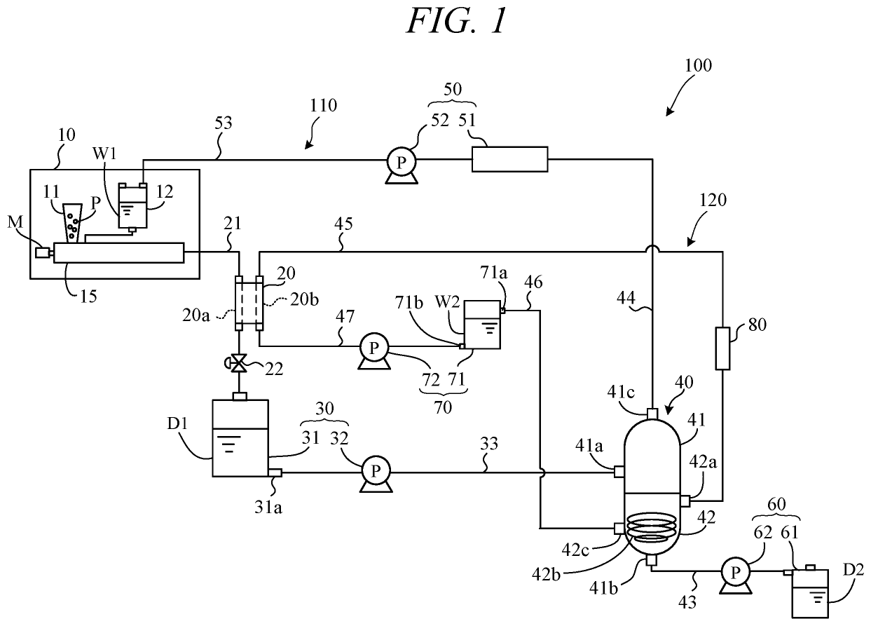

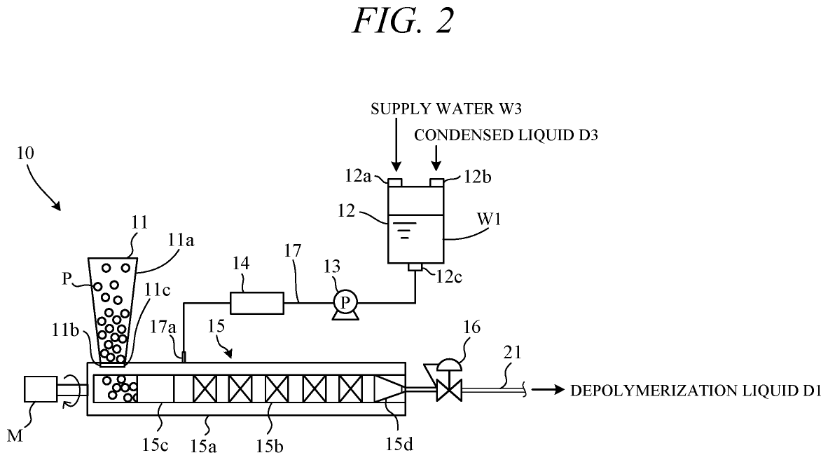

Hereinafter, an embodiment of the present invention will be described with reference to FIGS. 1 and 2. A depolymerization liquid generation system according to the embodiment of the present invention is configured as a system that concentrates a depolymerization liquid obtained by a depolymerization reaction of waste plastics using high-temperature and high-pressure water as a medium to reduce an amount of water in the depolymerization liquid. By reducing the amount of water in the depolymerization liquid, the transportation cost of the depolymerization liquid, the risk of freezing in winter, and the like can be suppressed.

Since a depolymerization liquid obtained by depolymerizing waste plastics using water under subcritical conditions as a medium contains a large amount of water with respect to ε-caprolactam as a main component, the depolymerization liquid has a large volume and the like. For this reason, for example, when the depolymerization liquid is transported to a polymerization plant to be polymerized, the transportation cost increases. In addition, when the amount of water in the depolymerization liquid is large, the depolymerization liquid may be frozen in winter, and a treatment such as thawing may be separately required. Therefore, in the present embodiment, the following depolymerization liquid generation system is configured so that the amount of water in the generated depolymerization liquid can be efficiently reduced and the transportation cost, and the risk of freezing in winter, and the like can be suppressed.

FIG. 1 is a diagram illustrating an example of a configuration of a depolymerization liquid generation system 100 according to an embodiment of the present invention. As illustrated in FIG. 1, a depolymerization liquid generation system 100 includes: a depolymerization liquid generation device 10 that generates a depolymerization liquid D1 by kneading waste plastics P and water (predetermined liquid) W1 under subcritical conditions; a heat exchanger 20 that cools the depolymerization liquid D1 generated by the depolymerization liquid generation device 10; a depolymerization liquid storage device 30 that stores the depolymerization liquid D1 cooled by the heat exchanger 20; a depolymerization liquid concentration device 40 that heats the depolymerization liquid D1 supplied from the depolymerization liquid storage device 30 with a heating medium W2 to generate a concentrated depolymerization liquid D2 and gas; a condensing device 50 that condenses the gas generated by the depolymerization liquid concentration device 40 to generate a condensed liquid D3 and supplies the condensed liquid D3 to the depolymerization liquid generation device 10; a concentrated liquid storage device 60 that stores the concentrated depolymerization liquid D2 generated by the depolymerization liquid concentration device 40; a circulation device 70 that circulates the heating medium W2 used for heating in the depolymerization liquid concentration device 40 between the heat exchanger 20 and the depolymerization liquid concentration device 40; and a heating device 80 that heats the heating medium W2 circuited by the circulation device 70 and cooled by heat exchange with the depolymerization liquid concentration device 40.

The depolymerization liquid generation device 10, the heat exchanger 20, the depolymerization liquid storage device 30, the depolymerization liquid concentration device 40, and the condensing device 50 constitute a concentrated liquid generation circuit 110 for generating the concentrated depolymerization liquid D2, and the depolymerization liquid concentration device 40, the circulation device 70, the heat exchanger 20, and the heating device 80 constitute a heat exchange circuit 120 for circulating the heating medium W2 used for generating the concentrated depolymerization liquid D2 while exchanging heat.

First, a schematic configuration of the concentrated liquid generation circuit 110 will be described. As described above, the concentrated liquid generation circuit 110 includes the depolymerization liquid generation device 10, the heat exchanger 20, the depolymerization liquid storage device 30, the depolymerization liquid concentration device 40, and the condensing device 50.

The depolymerization liquid generation device 10 is a chemical recycling device for waste plastics using a depolymerization reaction using water under the subcritical conditions as a medium, and a general device used for the depolymerization reaction can be used in the depolymerization liquid generation device 10.

FIG. 2 is a diagram schematically illustrating an example of a configuration of the depolymerization liquid generation device 10. As illustrated in FIG. 2, the depolymerization liquid generation device 10 includes a hopper 11 into which the waste plastics P are charged, a first liquid storage tank 12 in which the predetermined liquid W1 is stored, a first pump 13 that sends the predetermined liquid W1 stored in the first liquid storage tank 12, a heater 14 that heats the predetermined liquid W1 sent by the first pump 13, a kneader 15 that kneads the waste plastics P and the predetermined liquid W1, and a back pressure valve 16 that constantly holds a pressure in the kneader 15.

The hopper 11 is connected to the upstream side of the kneader 15, and supplies the charged waste plastics P to the kneader 15. More specifically, the hopper 11 has an accommodation portion 11a that is configured to be able to accommodate the waste plastics P, and an opening/closing portion 11b that is capable of switching between a supply state in which the waste plastics P accommodated in the accommodation portion 11a are supplied to the kneader 15 and a cutoff state in which the supply is cut off. The accommodation portion 11a is formed in a substantially trapezoidal shape in longitudinal cross-sectional view, and is configured to be able to supply the waste plastics P to the kneader 15 from a supply port 11c provided at a lower end. The opening/closing portion 11b is provided in the supply port 11c, and the amount of the waste plastics P supplied to the kneader 15 is adjusted by controlling the opening/closing portion 11b.

The first liquid storage tank 12 is connected to the kneader 15 via a liquid supply line 17, and supplies the predetermined liquid W1 to the kneader 15 via the liquid supply line 17. More specifically, one end of the liquid supply line 17 is connected to the first liquid storage tank 12, the other end of the liquid supply line 17 is connected to the downstream side of a connection portion of the hopper 11 in the kneader 15, and the predetermined liquid W1 is supplied to the downstream side of the hopper 11. In addition, a droplet nozzle 17a is disposed at the other end of the liquid supply line 17, and the predetermined liquid W1 is supplied into the kneader 15 as fine droplets through the droplet nozzle 17a.

The first liquid storage tank 12 has a supply portion 12a used for supplying supply water W3 mainly constituting the predetermined liquid W1, and a mixing portion 12b used for mixing the condensed liquid D3 generated by the condensing device 50. That is, the predetermined liquid W1 is constituted by the supply water W3 and the condensed liquid D3. The first liquid storage tank 12 has a discharge portion 12c to which one end of the liquid supply line 17 is connected and from which the predetermined liquid W1 is discharged. Each of the supply portion 12a, the mixing portion 12b, and the discharge portion 12c is provided with an opening/closing valve (not illustrated) capable of switching an opening/closing state, and a supply amount and the like are controlled by controlling the opening/closing valve.

The first pump 13 is disposed on the downstream side of the first liquid storage tank 12 in the liquid supply line 17, and includes a positive displacement pump such as a high-pressure diaphragm pump or a plunger pump. The predetermined liquid W1 stored in the first liquid storage tank 12 is supplied to the kneader 15 at a high pressure (for example, 17 MPa or more) by driving of the first pump 13.

The heater 14 is disposed on the downstream side of the first pump 13 in the liquid supply line 17, and includes a heater or the like capable of heating a pipe forming the liquid supply line 17. When the predetermined liquid W1 sent by the first pump 13 is injected into the kneader 15 through the droplet nozzle 17a of the liquid supply line 17, the predetermined liquid W1 is supplied at a high temperature (for example, 240° C. or more) by the heater 14 so that the melted waste plastics do not solidify at the tip of the droplet nozzle 17a.

The kneader 15 includes an extruder in which a screw 15b is stored in a cylindrical cylinder 15a, and is configured such that the inside of the cylinder 15a is under the subcritical conditions. More specifically, the cylinder 15a is provided with a heating portion 15c between the connection portion of the hopper 11 and the connection portion (the other end) of the liquid supply line 17, and a temperature in the cylinder 15a is held at a high temperature (for example, 350° C.) by the heating portion 15c. The waste plastics P charged from the hopper 11 are melted by the heating portion 15c. A downstream end 15d of the cylinder 15a is formed in a tapered shape (diaphragm shape). By forming the downstream end 15d in a tapered shape, the screw 15b is rotated by a motor M to knead the waste plastics P and the predetermined liquid W1 and extrude the waste plastics P and the predetermined liquid W1 toward the downstream side. As a result, the pressure in the cylinder 15a becomes high (for example, 17 MPa or more). In this way, the inside of the cylinder 15a are under the subcritical conditions, and the waste plastics P and the predetermined liquid W1 are kneaded under the subcritical conditions, so that the waste plastics P are depolymerized. In the cylinder 15a, the subcritical conditions are held by the back pressure valve 16 connected to the downstream end 15d, and the downstream end 15d to which the back pressure valve 16 is connected is configured to have a lower temperature (for example, 295° C.) than the upstream side.

The kneader 15 according to the present embodiment includes a twin screw extruder in which two screws 15b are stored, and is superior in homogeneity and dispersibility during kneading to a single screw extruder in which one screw is stored.

As illustrated in FIG. 1, the heat exchanger 20 is provided on the downstream side of the depolymerization liquid generation device 10, and exchanges heat between the high-temperature depolymerization liquid D1 discharged from the depolymerization liquid generation device 10 and the heating medium W2 (in the present embodiment, water) cooled by heat exchange with the depolymerization liquid concentration device 40. The heat exchanger 20 has a first flow path 20a through which the depolymerization liquid D1 flows and a second flow path 20b through which the heating medium W2 flows. The high-temperature depolymerization liquid D1 and the cooled heating medium W2 are caused to flow through the first flow path 20a and the second flow path 20b, respectively, so that the heat of the depolymerization liquid D1 is conducted to the heating medium W2, and the heat exchange between the depolymerization liquid D1 and the heating medium W2 is performed. As a result, the depolymerization liquid D1 is cooled by the heating medium W2 and reaches a predetermined temperature (for example, 83° C.). On the other hand, the heating medium W2 is heated by the depolymerization liquid D1 and becomes water vapor at a predetermined temperature (for example, 120° C.).

The first flow path 20a is provided in a cooling line 21 having one end connected to the discharge portion of the depolymerization liquid generation device 10 and the other end connected to a depolymerization liquid storage tank 31 of the depolymerization liquid storage device 30. The cooling line 21 is provided with an electromagnetic valve 22 on the downstream side of the first flow path 20a, and the amount of the depolymerization liquid D1 supplied to the depolymerization liquid storage tank 31 can be adjusted by controlling the electromagnetic valve 22. Note that the second flow path 20b of the heat exchanger 20 will be described in detail when the heat exchange circuit 120 is described.

The depolymerization liquid storage device 30 is provided on the downstream side of the heat exchanger 20, and stores the depolymerization liquid D1 cooled by the heat exchanger 20. The depolymerization liquid storage device 30 also has a function as a buffer for temporarily storing the depolymerization liquid D1 supplied to the depolymerization liquid concentration device 40 in the concentrated liquid generation circuit 110.

The depolymerization liquid storage device 30 is connected to the depolymerization liquid concentration device 40 through a supply line 33, and supplies the depolymerization liquid D1 to the depolymerization liquid concentration device 40 through the supply line 33. More specifically, the depolymerization liquid storage device 30 has a depolymerization liquid storage tank 31 that stores the depolymerization liquid D1, and a second pump 32 that sends the depolymerization liquid D1 stored in the depolymerization liquid storage tank 31 to the depolymerization liquid concentration device 40. The supply line 33 has one end connected to a discharge portion 31a of the depolymerization liquid storage tank 31, and the other end connected to a first supply portion 41a of the depolymerization liquid concentration device 40. The second pump 32 is disposed on the downstream side of the depolymerization liquid storage tank 31 in the supply line 33.

The depolymerization liquid concentration device 40 is a vacuum concentration device that heats a raw material in a reduced pressure state, thereby lowering a boiling point of water (predetermined liquid W1) contained in the raw material and concentrating the raw material at a relatively low temperature. In the depolymerization liquid concentration device 40, a general vacuum concentration type gas-liquid separation device or the like can be used. The depolymerization liquid concentration device 40 is provided on the downstream side of the depolymerization liquid storage device 30, and heats the depolymerization liquid D1 as the raw material in a reduced pressure state, thereby concentrating the depolymerization liquid D1 and generating the concentrated depolymerization liquid D2 and gas (water vapor). More specifically, the depolymerization liquid concentration device 40 has a device body 41 and a heating portion 42 that heats the device body 41. The device body 41 is configured to be able to reduce the internal pressure (for example, to 0.02 MPa). Note that the heating portion 42 will be described in detail when the heat exchange circuit 120 is described.

The device body 41 has a first supply portion 41a to which the depolymerization liquid D1 is supplied, a concentrated liquid discharge portion 41b that discharges the generated concentrated depolymerization liquid D2, and a gas discharge portion 41c that discharges the generated gas. The first supply portion 41a is provided in an upper portion of the device body 41, and the other end of the supply line 33 is connected to the first supply portion 41a. The depolymerization liquid D1 sent by the second pump 32 flows into the device body 41 from the first supply portion 41a through the supply line 33.

The concentrated liquid discharge portion 41b is provided at a lower end of the device body 41 and is connected to the concentrated liquid storage device 60 via a first discharge line 43. The concentrated depolymerization liquid D2 concentrated and generated by the depolymerization liquid concentration device 40 is sent from the concentrated liquid discharge portion 41b to the concentrated liquid storage device 60 through the first discharge line 43.

Here, the concentrated liquid storage device 60 has a concentrated liquid storage tank 61 that stores the concentrated depolymerization liquid D2, and a third pump 62 that sends the concentrated depolymerization liquid D2 generated by the depolymerization liquid concentration device 40 to the concentrated liquid storage tank 61. The other end of the first discharge line 43 having one end connected to the concentrated liquid discharge portion 41b is connected to the concentrated liquid storage tank 61, and the third pump 62 is provided in the first discharge line 43. The concentrated depolymerization liquid D2 generated by the depolymerization liquid concentration device 40 is stored in the concentrated liquid storage tank 61 until the concentrated depolymerization liquid is transported to a polymerization plant for repolymerizing the concentrated depolymerization liquid D2.

The gas discharge portion 41c is provided at the upper end of the device body 41, and is connected to the condensing device 50 via a second discharge line 44. The gas generated by the depolymerization liquid concentration device 40 is sent from the gas discharge portion 41c to the condensing device 50 through the second discharge line 44.

The condensing device 50 has a condenser 51 that condenses the gas (mainly water vapor) sent from the gas discharge portion 41c through the second discharge line 44 to generate a condensed liquid D3 (mainly water), and a fourth pump 52 that sends the gas from the gas discharge portion 41c to the condenser 51. The condenser 51 is a device that condenses and liquefies gas into a liquid by heat exchange with air or cold water, and a general condenser used for condensing water vapor or the like can be used in the condenser 51.

The condenser 51 has the upstream side connected to the second discharge line 44 and the downstream side connected to the mixing line 53, and the condensed liquid D3 generated by the condenser 51 flows into the mixing line 53. The mixing line 53 has one end connected to a downstream end of the condenser 51 and the other end connected to the mixing portion 12b of the first liquid storage tank 12, and the condensed liquid D3 condensed and generated by the condenser 51 is mixed from the condenser 51 into the first liquid storage tank 12 through the mixing line 53. The fourth pump 52 is provided in the mixing line 53, and sends the condensed liquid D3 generated by the condenser 51 toward the first liquid storage tank 12.

Next, a schematic configuration of the heat exchange circuit 120 will be described. As described above, the heat exchange circuit 120 includes the depolymerization liquid concentration device 40, the circulation device 70, the heat exchanger 20, and the heating device 80.

As illustrated in FIG. 1, the depolymerization liquid concentration device 40 has the device body 41 and the heating portion 42, and the heating portion 42 is provided in a lower portion of the device body 41. The heating portion 42 has an inflow portion 42a into which the heating medium W2 flows, a circulation portion 42b that circulates the flowing heating medium W2 and heats the device body 41 by heat exchange, and a discharge portion 42c from which the heating medium W2 circulated in the circulation portion 42b is discharged.

The inflow portion 42a is provided in an upper portion of the heating portion 42 and is connected to one end of the heat exchanger 20 via a first circulation line 45. More specifically, one end of the first circulation line 45 is connected to one end of the second flow path 20b of the heat exchanger 20, and the other end of the first circulation line 45 is connected to the inflow portion 42a of the heating portion 42. The first circulation line 45 is provided with the heating device 80 that further heats the heating medium W2 heated by the heat exchange in the heat exchanger 20. The heating device 80 further heats the heating medium W2 so that the heating medium W2 has a temperature necessary for concentrating the depolymerization liquid D1. Note that such heating may be performed by the heating portion 42 instead of the heating device 80, and in this case, the heating device 80 is unnecessary.

The circulation portion 42b is interposed between the inflow portion 42a and the discharge portion 42c, and is formed so that the heating medium W2 can circulate. The circulation portion 42b also has a function of heating the circulating heating medium W2. The discharge portion 42c is provided in a lower portion of the heating portion 42 and is connected to the circulation device 70 via a second circulation line 46. In the depolymerization liquid concentration device 40, the heat of the heating medium W2 is conducted to the depolymerization liquid D1, and heat exchange between the depolymerization liquid D1 and the heating medium W2 is performed. As a result, the depolymerization liquid D1 is heated by the heating medium W2, and water (predetermined liquid W1) in the depolymerization liquid D1 is vaporized and removed, so that the depolymerization liquid D1 is concentrated to generate the concentrated depolymerization liquid D2. The heating medium W2 is cooled by the depolymerization liquid D1 to become liquid water.

The circulation device 70 has a second liquid storage tank 71 that stores the heating medium W2 discharged from the discharge portion 42c, and a fifth pump 72 that circulates the heating medium W2. The second liquid storage tank 71 has an inflow portion 71a and a discharge portion 71b, and the inflow portion 71a is connected to the other end of the second circulation line 46 having one end connected to the discharge portion 42c. One end of the third circulation line 47 is connected to the discharge portion 71b, and the other end of the third circulation line 47 is connected to the other end of the second flow path 20b of the heat exchanger 20. The fifth pump 72 is provided in the third circulation line 47, and circulates the heating medium W2 in the heat exchange circuit 120.

Next, processing of generating the concentrated depolymerization liquid D2 by the depolymerization liquid generation system 100 configured as described above will be described. In the depolymerization liquid generation system 100, processing of generating the concentrated depolymerization liquid D2 by the concentrated liquid generation circuit 110, and heat exchange processing of the heating medium W2 used for generating the concentrated depolymerization liquid D2 in the concentrated liquid generation circuit 110 by the heat exchange circuit 120 are executed.

First, the processing of generating the concentrated depolymerization liquid D2 by the concentrated liquid generation circuit 110 will be described.

In the processing of generating the concentrated depolymerization liquid D2, first, the depolymerization liquid D1 is generated by the depolymerization liquid generation device 10. The depolymerization liquid D1 is generated by using a depolymerization reaction of the waste plastics P using the predetermined liquid W1 under the subcritical conditions as a medium. The generated depolymerization liquid D1 is cooled by the heat exchanger 20 and stored in the depolymerization liquid storage tank 31 under an atmospheric pressure. The depolymerization liquid D1 stored in the depolymerization liquid storage tank 31 is heated in a reduced pressure state in the depolymerization liquid concentration device 40 to be gas-liquid separated into the concentrated depolymerization liquid D2 mainly containing ε-caprolactam as a decomposition product of the depolymerization reaction and the gas (water vapor).

The generated concentrated depolymerization liquid D2 is stored in the concentrated liquid storage device 60 under the atmospheric pressure and stored until the concentrated depolymerization liquid is transported to the polymerization plant. By gas-liquid separation, the concentrated depolymerization liquid D2 has the smaller water content than the depolymerization liquid D1 generated by the depolymerization liquid generation device 10, and the content of ε-caprolactam (decomposition product) contained in the same volume of raw material liquid also increases. Therefore, freezing and the like in winter can be suppressed, more ε-caprolactam can be transported by the same transportation means, and the transportation cost can also be suppressed.

On the other hand, the gas separated and generated by the depolymerization liquid concentration device 40 is subjected to heat exchange by the condenser 51 to become the condensed liquid D3 slightly containing ε-caprolactam, and is mixed into the first liquid storage tank 12 in which the predetermined liquid W1 serving as a medium for depolymerizing the waste plastics P is stored. Since the supply water W3 used for the predetermined liquid W is supplied to the first liquid storage tank 12, the predetermined liquid W1 includes the supply water W3 and the condensed liquid D3. As described above, when the concentrated depolymerization liquid D2 is generated, the gas (water vapor) separated and generated is condensed and reused as the predetermined liquid W1 (water) for depolymerizing the waste plastics P, so that the concentrated depolymerization liquid D2 can be efficiently generated.

Next, the heat exchange processing of the heating medium W2 by the heat exchange circuit 120 will be described.

In the heat exchange processing of the heating medium W2, the heating medium W2 for cooling the depolymerization liquid D1 by the heat exchanger 20 is circulated by the circulation device 70, and the depolymerization liquid D1 is heated by the depolymerization liquid concentration device 40. As described above, the heating medium W2 is used for cooling and heating the depolymerization liquid D1, and the heat energy generated by the heat exchanger 20 is used in the depolymerization liquid concentration device 40, so that the heat energy can be efficiently used when the concentrated depolymerization liquid D2 is generated.

According to the present embodiment, the following functions and effects can be achieved.

(1) The depolymerization liquid generation system 100 according to the present embodiment includes the depolymerization liquid generation device 10 that kneads the waste plastics P and the predetermined liquid W1 to generate the depolymerization liquid D1, the depolymerization liquid concentration device 40 that heats the depolymerization liquid D1 generated by the depolymerization liquid generation device 10 to separate the depolymerization liquid D1 into the concentrated depolymerization liquid D2 and the gas, and the condensing device 50 that condenses the gas separated by the depolymerization liquid concentration device 40 to generate the condensed liquid D3 (FIG. 1). The depolymerization liquid generation device 10 includes the kneader 15 that kneads the waste plastics P and the predetermined liquid W1. The condensed liquid D3 generated by the condensing device 50 is mixed into the kneader 15 (FIG. 2).

With this configuration, it is possible to generate the concentrated depolymerization liquid D2 in which the amount of water contained in the depolymerization liquid D1 obtained by the depolymerization reaction of the waste plastics P using the predetermined liquid W1 (water) as the medium is reduced. Therefore, since the volume at the time of transportation to the polymerization plant is smaller than that volume of the original depolymerization liquid D1, the transportation cost can be suppressed, and freezing and the like in winter can also be suppressed by reducing the water amount. Furthermore, since the condensed liquid D3 obtained by condensing the gas separated at the time of generating the concentrated depolymerization liquid D2 is mixed into the predetermined liquid and reused as water used in the depolymerization reaction, the concentrated depolymerization liquid D2 can be efficiently generated.

(2) The depolymerization liquid generation device 10 further includes the heater 14 that heats the predetermined liquid W1 supplied from the first liquid storage tank 12 to the kneader 15 (FIG. 2). With this configuration, when the predetermined liquid W1 is supplied into the kneader 15, it is possible to prevent the waste plastics P melted in the kneader 15 from solidifying at the supply location of the predetermined liquid W1.

(3) The depolymerization liquid generation system 100 further includes the heat exchanger 20 that cools the depolymerization liquid D1 generated by the depolymerization liquid generation device 10 by heat exchange with the heating medium W2, and the circulation device that circulates the heating medium W2 between the heat exchanger 20 and the depolymerization liquid concentration device 40 (FIG. 1). The depolymerization liquid concentration device 40 heats the depolymerization liquid D1 by heat exchange with the heating medium W2 (FIG. 1). With this configuration, even when the depolymerization liquid D1 is heated by the depolymerization liquid concentration device 40 to be separated into the concentrated depolymerization liquid D2 and the gas, the heating medium W2 used for heating can be efficiently used. That is, since the heating medium W2 heated by the heat exchange in the heat exchanger 20 is used for the heat exchange in the depolymerization liquid concentration device 40, the cooling of the depolymerization liquid D1 in the heat exchanger 20 and the heating of the depolymerization liquid D1 in the depolymerization liquid concentration device 40 can be efficiently performed.

(4) The depolymerization liquid generation system 100 further includes the depolymerization liquid storage device 30 that stores the depolymerization liquid D1 supplied to the depolymerization liquid concentration device 40. The depolymerization liquid D1 cooled by the heat exchanger 20 is stored in the depolymerization liquid storage device 30 (FIG. 1). As described above, the depolymerization liquid D1 supplied from the depolymerization liquid generation device 10 to the depolymerization liquid concentration device 40 is cooled by the heat exchanger 20 and temporarily stored in the depolymerization liquid storage tank 31, so that the depolymerization liquid concentration treatment by the depolymerization liquid concentration device 40 can be stably performed.

The above embodiment can be modified into various forms. Hereinafter, variations will be described.

In the above embodiment, the depolymerization liquid generation system 100 includes the depolymerization liquid storage device 30. However, the depolymerization liquid D1 cooled by the heat exchanger 20 may be directly supplied to the depolymerization liquid concentration device 40 without providing the depolymerization liquid storage device 30.

In the above embodiment, the vacuum concentration device has been used as the depolymerization liquid concentration device 40 that heats the depolymerization liquid D1 to separate the depolymerization liquid D1 into the concentrated depolymerization liquid and the gas. However, the depolymerization liquid concentration device is not limited thereto. As the depolymerization liquid concentration device, a general gas-liquid separation device can be used.

In the above embodiment, water has been used as the heating medium circulating in the heat exchange circuit 120. However, a medium other than water such as oil may be used as the heating medium.

In the above embodiment, the description has been given using the example in which the depolymerization liquid D1 is heated by the heating medium W2 heated by the heating device 80. However, the depolymerization liquid D1 may be heated by the heating medium W2 heated by the heating portion 42, or the depolymerization liquid D1 may be heated by the heating medium W2 heated by the heating device 80 and the heating portion 42. When the heating medium W2 has a heat amount necessary and sufficient for concentrating the depolymerization liquid D1, the depolymerization liquid D1 may be heated by the heating medium W2 heated by heat exchange in the heat exchanger 20 without heating the heating medium W2 by the heating device 80 or the heating portion 42.

The above embodiment can be combined as desired with one or more of the aforesaid modifications. The modifications can also be combined with one another.

According to the present invention, it becomes possible to efficiently reduce the amount of water in the generated depolymerization liquid to suppress the transportation cost, the risk of freezing in winter, and the like.

Above, while the present invention has been described with reference to the preferred embodiments thereof, it will be understood, by those skilled in the art, that various changes and modifications may be made thereto without departing from the scope of the appended claims.

1. A depolymerization liquid generation system, comprising:
a depolymerization liquid generation device configured to knead waste plastics and predetermined liquid to generate depolymerization liquid;
a depolymerization liquid concentration device configured to heat the depolymerization liquid generated by the depolymerization liquid generation device to separate the depolymerization liquid into concentrated depolymerization liquid and gas; and
a condensing device configured to condense the gas separated by the depolymerization liquid concentration device to generate condensed liquid, wherein
the depolymerization liquid generation device includes a kneader configured to knead the waste plastics and the predetermined liquid, wherein
the condensed liquid generated by the condensing device is mixed into the kneader.

2. The depolymerization liquid generation system according to claim 1, wherein
the depolymerization liquid generation device further includes a heater configured to heat the predetermined liquid supplied to the kneader.

3. The depolymerization liquid generation system according to claim 1, wherein
the depolymerization liquid generation device further includes a liquid storage tank configured to store the predetermined liquid supplied to the kneader, wherein
the condensed liquid generated by the condensing device is mixed into the kneader through the liquid storage tank.

4. The depolymerization liquid generation system according to claim 1, further comprising:
a heat exchanger configured to cool the depolymerization liquid generated by the depolymerization liquid generation device by heat exchange with heating medium; and
a circulation device configured to circulate the heating medium between the heat exchanger and the depolymerization liquid concentration device, wherein
the depolymerization liquid concentration device heats the depolymerization liquid by heat exchange with the heating medium.

5. The depolymerization liquid generation system according to claim 4, further comprising:
a depolymerization liquid storage device configured to store the depolymerization liquid supplied to the depolymerization liquid concentration device, wherein
the depolymerization liquid cooled by the heat exchanger is stored in the depolymerization liquid storage device.

6. The depolymerization liquid generation system according to claim 4, wherein
the heating medium is water.

7. The depolymerization liquid generation system according to claim 1, wherein
the predetermined liquid is water.
